(19) United States
(12) Patent Application Publication
(10) Pub. No.: US 2002/0190972 A1
(43) Pub. Date: Dec. 19, 2002

(54) Display screen performance or content verification methods and apparatus

(76) Inventor: Antony Ven de Van, Kowloon (HK)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/147,327

(22) Filed: May 17, 2002

Related U.S. Application Data
(60) Provisional application No. 60/291,331, filed on May 17, 2001.

(51) Int. Cl. G09G 5/00

(52) U.S. Cl. 345/204

(57) ABSTRACT

This invention relates to a method or apparatus for provision of display screens. Display screens used in remote locations such as those as may be used for billboards etc. run the risk of tampering or interference with the data supplied to the screens for display. This may particularly be preferment with billboards controlled by the worldwide web. The invention sets out methods of verifying the content to be displayed on the screen including checking the incoming data feed or checking the actual image displayed on the screen. In addition, the invention provides various methods of monitoring the performance of the screen to verify the images being displayed and to adjust for degradation of display components or otherwise monitor the performance of the display.

### FIELD OF THE INVENTION

This invention relates to display screen performance or content verification methods and apparatus and, in particular, although not necessarily solely, to methods and apparatus applicable to pixelated display screens for the public display of images.

### BACKGROUND TO THE INVENTION

In recent years, large screen displays for the presentation of time-dependent images such as video have become more common. Many such displays are used in fixed locations such as sporting grounds or in temporary locations for special events such as concerts or large public gatherings.

Even more recently, such displays are starting to be used for the provision of advertising in fixed locations. They may be used in the same manner as billboards but providing more detailed graphical images through the use of time dependent data feeds such as video. With the increasing use of such screens fixed to buildings, inside underground train stations or at roadside, there is an increasing need to control the data feed and the unit itself remotely. Typically, a data feed for a series of advertisements or messages on such a display screen can be fed to the display screen via the worldwide web, or by direct landline or wireless technologies. Usually, the data for a series of such advertisements would be fed to the control of a display screen and stored for use although a continuous data feed or intermittent feeds for special messages are always possible.

The remote location of such displays away from the view of a controller and through various data links can cause a number of problems. The first of these problems is one of security. If data is fed remotely to a billboard in either a continuous or intermittent manner via non-secure feeds such as the Internet, there is a risk of data tampering, hacking or disruption to the signal. One of the most embarrassing of these would be actual hacking into the data feed to alter or replace the displayed messages. Regardless, any tampering or disruption may alter the character of an advertisement running on the display and reduce the effectiveness of the advertising. Stopping the potential for such actions is of paramount importance to advertisers paying for time usage on such displays.

Aside from the security risk to the data fed to the display or ultimately displayed on the screen, there is a further problem relating to possible damage or failure of the display or part of the display. In general, a full failure of the display is more noticeable or easier to monitor from the power demand drawn by the display. However, a partial failure of the display such as the failure of the functioning of one particular board or module within the display is more difficult. Furthermore, if there is a problem with the driving circuitry that leads to incorrect images being displayed rather than no images at all, monitoring power demands may not provide any effective monitoring.

When such display screens are used for the advertising of paid advertisements, those paying for the advertisements would find it desirable to have some verification that the image is being displayed as desired. When placed in remote locations, constant visual monitoring of the display is not possible and a form of remote monitoring can assist in providing verification to advertisers as well as providing accurate real-time site-specific information for billing purposes.

A yet further problem with display screens is exhibited with particularly, although not solely, LED based display screens. The performance of an individual LED lamp varies with temperature. Furthermore, these variations with temperature are not constant amongst the different types of LEDs used. Different materials are used in the manufacture of red, blue and green LEDs and each will have a different characteristic response to variations in temperature.

Although it is possible to include a temperature sensor on a display board and compensate for temperature by adjusting the current to the different sets of LEDs, all such adjustments need to be made from empirical data provided to the display screen prior to its site placement. The variation in response of these LEDs as a result of temperature fluctuations may change over a period of time as the LED degrades causing difficulty in ensuring accurate compensation to temperature fluctuations.

Again, largely due to material differences, the different types of LEDs used for red, blue and green LEDs degrade in a different manner overtime. The degradation is not only due to temperature fluctuations but also humidity and workload of the LEDs. It is particularly difficult to provide meaningful compensating data to the display screen to take into account all of these possible fluctuations to the performance of the LEDs as a group.

On this basis, it would be desirable to be able to compensate from real-time monitoring of the performance of the display.

### OBJECT OF THE INVENTION

It is an object of the present invention to provide method and apparatus for a display that overcomes some of the disadvantages of the prior art or at least provides the public with a useful choice.

### SUMMARY OF THE INVENTION

Accordingly, in a first aspect, the invention may broadly be said to consist in a display for displaying a time-dependent image comprising:

a display panel for displaying the image;

receiving means to receive an incoming data stream containing images and including at least an intermittent verification signal;

a processor to process the data feed and drive the display to present said images; and

a control means to check for the verification signal in either the data feed or the display image and control the display if an appropriate verification signal is not present.

Preferably the control means will control the display by removing from display any images that are not accompanied by a verification signal.

Preferably the control means will also provide a signal to a remote controller to alert as to the absence of the verification signal.

Preferably said control means is included with said processor of the data feed for the display of the image.

Alternatively said control means includes checking for the presence of a verification signal provided to at least a visible or non-visible portion of the display.

Preferably said visible or non-visible portion of the display is read by at least one optical sensor to check for the verification signal.

Preferably said verification signal is provided to a visible portion of the display in a manner not perceptible to a human observer of the display.

Preferably said apparatus also transmits acknowledgement of receipt or display of correct images to said remote controller.

Accordingly, in a second aspect, the invention may broadly be said to consist in a method verifying a data feed or image on a remote display screen comprising:

combining a verification signal in a data feed containing the desired images for display;

sending said data feed and said verification signal to said display;

checking the incoming data feed or the display image for the presence of the verification signal; and

controlling the display screen in response to receipt of a data feed or display of an image not containing said verification signal.

Preferably said step of controlling the display screen comprises failing to display images not containing said verification signal and/or transmitting a signal to a remote controller indicating the receipt or display of images without said verification signal.

Preferably said step of checking for the verification signal is done on the incoming data feed.

Alternatively or additionally, the step of checking for the verification signal is performed on the display image.

Alternatively or additionally, said step of checking is performed on a non-visible display portion.

Preferably said checking of the presence of a verification signal in a display image comprises optically checking for the omission of a verification signal by units within the display.

Preferably a method further includes transmitting a signal to a remote confirming receipt or display of data feeds or images containing the verification signal.

Accordingly, in a third aspect, the invention may broadly be said to consist in a method of monitoring the performance of a display comprising:

optically sensing output from at least a representative portion of visible or non-visible display units;

providing a test signal to said display units;

comparing said optically sensed output with an expected output; and

controlling said display in accordance with the results of said comparison.

Preferably said method comprises a step of testing visible display units in a manner not perceptible to the human eye.

Alternatively said method includes testing display units hidden from a viewer during normal display.

Preferably said display units not visible during normal use of the display also receive representative data representing the workload of visible display units.

Preferably said method includes provision of a specific test signal only to said representative portion of visible or non-visible display units.

Accordingly, in a fourth aspect, the invention may broadly be said to consist in a display for displaying time-dependent images comprising:

a display panel containing a plurality of display units for displaying said time-dependent images;

at least one optical sensor to sense output from at least a representative portion of visible or non-visible display units;

comparing means to compare the sensed optical output with an expected or desired output; and

control means to control the display in response to the result of said comparison.

Preferably said display contains display units that are not visible to an ordinary viewer of the display images.

Alternatively said display tests visible display units in a manner not perceptible to the human eye.

### BRIEF DESCRIPTION OF THE DRAWINGS

Preferred embodiments of the invention will now be described with reference to the following drawings in which:

FIG. 1 shows a diagrammatic view of a display apparatus in accordance with one embodiment of the invention;

FIG. 2 shows a diagrammatic view of a display screen in accordance with a further embodiment of the invention;

FIG. 3 shows a schematic diagram of the basic units of an embodiment of the invention;

FIG. 4 shows a diagrammatic view of a portion of a display panel suitable for a further embodiment of the invention;

FIG. 5 shows an alternative view of the portion of the apparatus shown in FIG. 4;

FIG. 6 shows a further view of a portion of a display panel in accordance with an embodiment of the invention;

FIG. 7 shows a portion of a display panel in accordance with a yet further embodiment of the invention;

FIG. 8 shows a view of a portion of a display panel in accordance with a yet further embodiment of the invention;

FIG. 9 shows a front view of a display in accordance with a yet further embodiment of the invention;

FIG. 10 shows a cross-sectional elevation through the apparatus of FIG. 9; and

FIG. 11 shows a cross-sectional elevation through a portion of a display panel in accordance with a yet further embodiment of the invention.

### DETAILED DESCRIPTION OF PREFERRED EMBODIMENTS

Referring to the drawings, various embodiments of the invention are described. Throughout the description, reference is made to display screens and display panels with the majority of the description being given in relation to LED display screens. It will be appreciated on reading the various embodiments that many aspects described may equally apply to other display screens such as plasma screens or CRT screens.

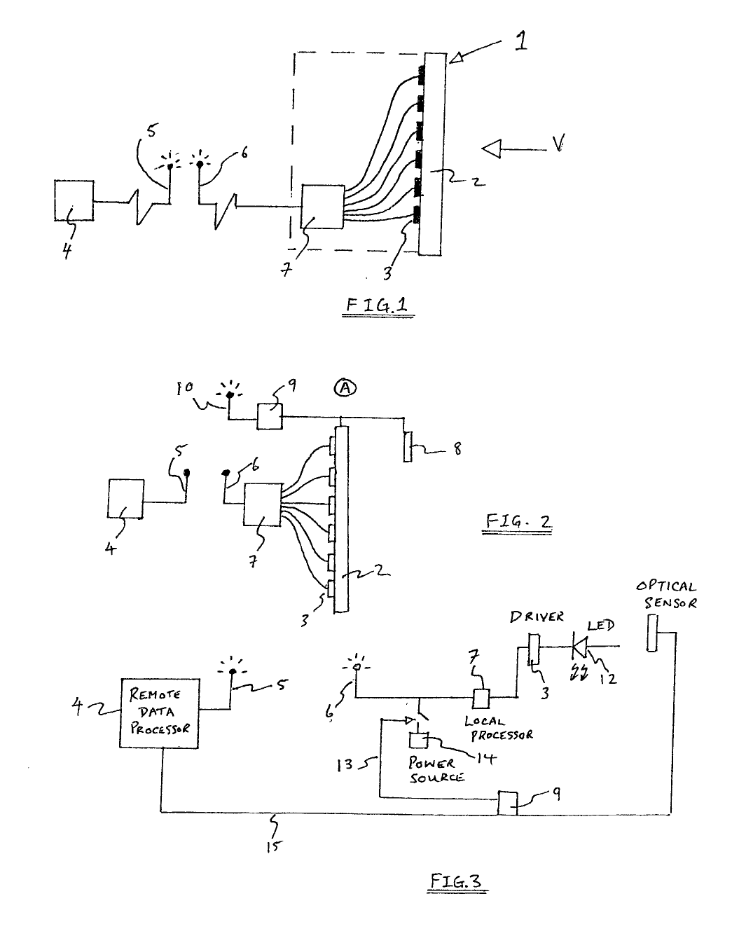

Referring to FIG. 1, one embodiment of the invention is shown in the form of a display screen 1 having a display panel 2 intended for viewing generally from the direction indicated by the arrow^{v}.

The display panel 2 may provide a substantially rectangular flat viewing surface and is shown in cross-section in FIG. 1.

The display panel 2 may have a plurality of PCBs or other such mounted circuits 3 behind the display panel to drive the processing of images.

In this embodiment, the display panel 1 may be provided in a remote location and received a data feed from a remote controller 4. This data feed may contain the images intended for display or a schedule for the display of already stored images. In either case, the remote controller 4 may provide the information through a transmission means 5 to a receiver 6 to receive the information from the remote controller 4. The information may be provided continuously to continuously display the data on the screen 2 or can be provided in bulk to be stored within a storage means contained within a processor 7 associated with the display panel 2.

The transmission of the information to the remote display can occur via a fixed data feed such as a fixed landline or through conventional land or wireless telephone or Internet transmission technologies.

Upon receipt of the information, the controller 7 passes the data to the necessary driving circuitry 3 and appropriate images are provided on the display 2.

In a first embodiment of the invention as shown, the remote controller 4 may provide data through the transmission means 5 and 6 that carries a verification signal or coded signal with the messages. The verification signal can be provided continuously with the data feed in an alternative data spectrum or can be intermittently spaced with the data. The processor 7, upon receiving the information, may include means to check for the existence of the verification signal before passing the remaining data to the display unit 2. In this manner, if the data feed to the remote display 2 is altered, corrupted or tampered with, the processor 7 can note the absence or alteration of the verification signal expected to receive and control the display unit 2 appropriately. Control of this display unit 2 in such circumstances may comprise shutting down the display unit to display no images or display of a predetermined message or other uncorrupted files that the processor 7 may already retain.

The verification signal can form part of a video feed to the display unit 2 with particular signals included at spaced frame sequences in the signal. Provided that the processor 7 is provided with knowledge of the expected verification signal included with a correct data transmission, the comparison can proceed.

A further embodiment of the apparatus is shown in FIG. 2. In this embodiment, a display panel 2 similar to that shown in FIG. 1 with the processor 7 and driving circuits 3 is provided. Similarly, the display panel receives signals from a remote controller 4 via transmission and receiving means 5 and 6.

Unlike the previous embodiment, the verification signal that may be included in the data feed is not checked by the initial processor. Alternatively, even if it is checked by the initial processor 7, this embodiment includes an alternative check for the verification signal.

This check comes in the form of an optical sensor 8 mounted to view at least a portion of the display panel. In this case, the optical sensor 8 will look for a verification signal in the form of a specific output on the portion of the display 2 viewed by the optical sensor 8. The portion of the display viewed by the optical sensor 8 can be passed to a processor 9 that compares this against the intended verification signal. The processor 9 may also include the control means to control the display panel 2 should the verification signal be absence from the portion of the display that is sensed by the optical sensor 8.

The optical sensor 8 can comprise a variety of pieces of apparatus including a simple digital camera of CCD array or other items to measure optical outputs from the portion of the display 2 visible to the sensor 8.

It will be noted that the processor 9 may also transmit signals from a transmitter 10 to return information to the remote controller 4. This return of information may comprise alerting the remote controller that a suitable verification signal was not received in the image as displayed so that corruption of the data feed can be investigated. Preferably, the transmitted signal from the transmitter 10 also includes confirmation when a correct image is received by the optical sensor 8.

When such displays are used for the presentation of advertising, confirmation of the correct display of an image can be useful in providing verification data for accounting purposes in billing the advertisers.

It will be appreciated that processors 7 and 9 and the receiver 6 and transmitter 10 may be combined with each other physically. A single processor can receive the incoming data feed for processing to the display images as well as receiving the output from the optical sensor 8 for verification.

In a yet further embodiment, the optical sensor 8 may provide data directly back to the remote controller 4 such that the comparison for the sake of verification is done by the remote controller 4 rather than at the display panel. However, such a system may be less reliable as it does require a continuous feed of data from the optical sensor 8 to the remote controller 4 and prevents independent operation of the display panel 2.

A general logic diagram is provided in FIG. 3 of the major components of the apparatus in FIG. 2. It can be seen that the remote data processor 4 is linked by transmitter 5 and receiver 6 to provide information to a local processor 7. This processor then provides data to the driving circuitry 3 to drive particular display units such as LED units 12. An optical sensor 8 can be directed to an individual or a plurality of such display units 12 and returned the information via the processor 9. If the processor 9 notes an unverified signal, a switch or other control means 13 can be operated to, for example in this embodiment, isolate the power source 14 from the display.

As described previously, the optical sensor or the processor 9 can also provide information back to the remote processor 4 via an information path 15. This information path 15 can be used to pass back alarms or alerts to the processor 4 should an unverified signal have been received or verification of correct receipt of images for billing purposes.

Referring to FIG. 2, in this case the optical sensor 8 might be directed to a portion of the front face of the display panel 2 being that to which the image visible to viewers is provided. If so, there may be a desire to ensure that the verification signal in the viewed image does not disrupt a viewer's perception of delivered time-dependent images. This is possible by providing the verification signal, to the entire display or only a portion of the display viewed by the optical sensor, in a very brief manner not perceptible to the human eye. For example, the inclusion of a coded verification pattern in every 50^{th} frame of video data feed would not be picked up by the human eye but could be sensed by the optical sensor 8 that is timed to look for the verification signal at pre-selected intervals or simply activated by the verification signal providing a sensed signal confirming the presence of the verification signal. The processor 9 can operate so as to ensure that the verification signal is received within an appropriate period such as a period of time for passage of more than 50 frames of a video data feed. No verification is received within a predetermined time period greater than the passage of, for example, 50 frames being the interval of inclusion of the verification signal, processor 9 can determine that the image is not verified.

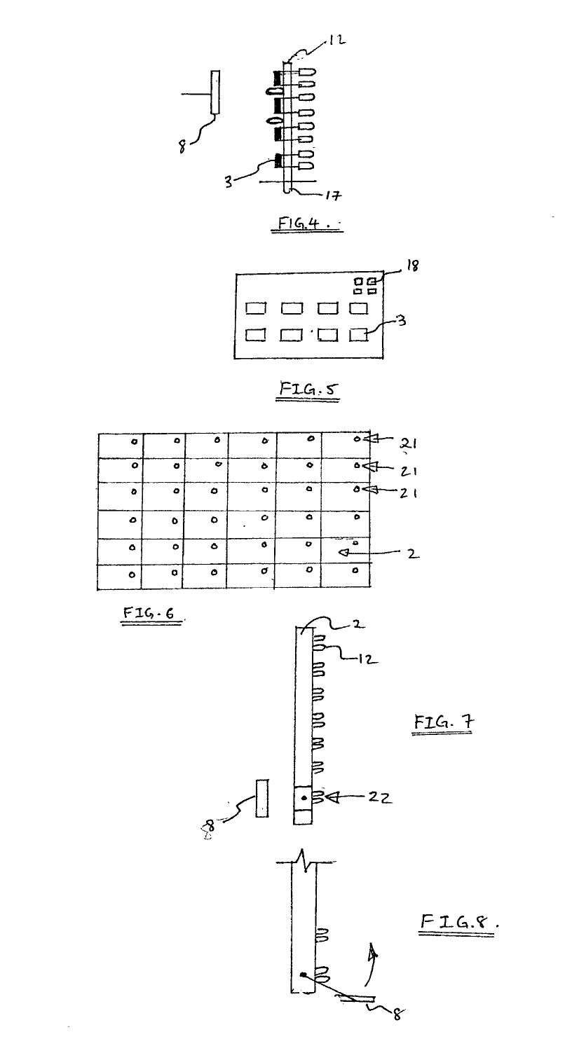

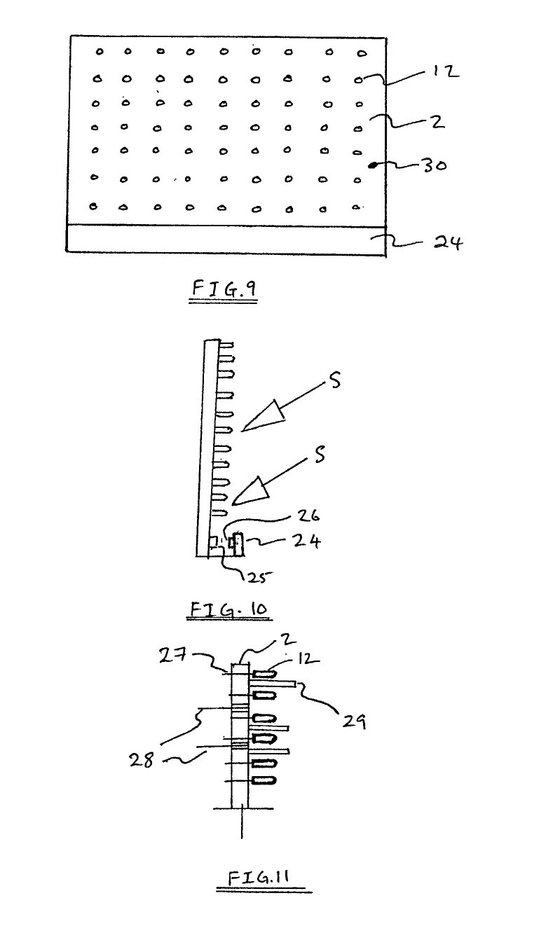

Referring to FIG. 4, a yet further embodiment of the invention is shown.

In this instance, a portion of the display panel 2 is shown in cross-section.

In the case of an LED display screen, it is typical for the display panel 2 to comprise a printed circuit board 17 with the driving circuitry 3 in the form of driver chips and circuits on the reverse side of the board 17 from the LEDs 12 forming the display. The LEDs 12 are generally grouped for control purposes into pixels comprising at least a red, blue and green LED.

In this embodiment, some additional non-visible display units in the form of LEDs 18 are provided. An optical sensor 8 may be positioned individually for each of the additional display units 18 or a larger optical sensor for a group of such display units 18.

In providing additional display units or LEDs 18 on the reverse of the PCB 17, the LEDs 18 can be provided with a signal direct from the drivers 3 or from the LEDs 12 that is either matched to particular LEDs 12 in the display or representative of a group of such LEDs.

When operating in this manner, the optical sensor is able to view the LEDs 18 and intermittently provide the LEDs 18 with a test signal. The test signal, for example, might comprise turning the additional LEDs 18 onto full intensity to test the degradation of the LED or its variation due to current temperatures. With the LEDs incorporated closely with the actual LEDs 12 forming the display, the temperature may be approximately equivalent.

The optical sensor 8 can measure the output from the test LEDs 18 on such intermittent occasions and, compare the reading in a processor described previously to determine whether the output from the LED has degraded whether by the instantaneous temperature of the LED or through gradual degradation overtime. It is able to consider the results from a number of such test LEDs over the display and compare the results to determine whether there should be a general adjustment to the current supply to LEDs of the same colour throughout the display to compensate for such degradation.

In between such intermittent test signals, the LED 18 can take a representative workload such as an average of the signals received by LEDs of the same colour in a neighbouring region of the display. This ensures the LED 18 degrades through workload at a similar rate to LEDs in a display.

Additionally, the provision of a verification signal as described previously to these test LEDs 18 can allow the optical sensor 8 to receive at verification signal intermittent of the LED 18's normal workload. This verification signal can be any signal that is either constant for all data intended for display or can vary for particular advertisements so that, as described previously, a display can confirm the running of a particular advertisement back to a remote location or a remote processor for billing purposes.

Referring to FIG. 5, a rear view of a PCB as shown in FIG. 4 is provided. It can be seen that the test LEDs 18 can be provided together in a small group to replicate a pixel and receive a signal representative of the signal being provided to the LEDs on the front of the board to ensure relative degradation occurs.

Referring to FIG. 6, a larger portion of a display screen-is shown. In practice, display screens are often put together from a plurality of smaller modules. For convenience, it may be desirable to include one or more test pixels 21 on each of the display panels 2. This provides multiple test pixels for comparison using optical sensors so that the degradation and other effects can be averaged out over the board. The screen may be less reliable if all the monitoring and compensation of current is performed using only a single test pixel as individual LEDs have slightly different responses to all the various factors affecting performance although an average over many such test pixels can alleviate this.

By utilizing one or more pixels on each board that receive a signal matching one or an average of the pixels on the front of that particular board, it will be appreciated that during normal operation, the test pixels together will form a picture representative of the image currently on display on the front of the display.

This can be used as a further or alternative verification of the image on the board. No particular verification signal needs to be included in the data feed although this may still be used in addition if desired.

The output from the group of test pixels 21 can be combined and transmitted to the remote controller. If a whole display contains an array of say, 5,000 smaller modules each carrying one test pixel, the received image at the remote controller will be a picture in the form of 100×50 pixels showing the image currently on display. It effectively provides a coarse compressed image back to the remote controller verifying the actual image on display in real time.

Referring now to FIG. 7, an alternative mechanism is shown. In this embodiment, the display panel 2 is again provided with a plurality of forward facing LEDs 12. Rather than utilized additional display units placed on the back of the PCB, it can be possible to use actual units of the display to act as test units for testing degradation of the LEDs or for providing verification signals. However, in endeavouring to utilize portions of the display itself, it is preferable to do so in a manner that is not perceptible to a viewer so as not to disrupt the display image at all.

As shown in FIG. 7, a small portion of the display panel 2 in the form of a test portion 22 might be rotatably mounted so as to rotate towards the reverse of the PCB and allow analysis by an optical sensor 8. Provided the rotation is performed quickly, this can be done without any substantial disruption to the overall picture. The advantage of rotating the pixel is to minimize direct sunlight on the LEDs when tested which might disrupt the analysis of the output from the LEDs.

In a similar manner, FIG. 8 shows a movable optical sensor 8 that may be quickly rotated in front of LEDs to measure the output. If the sensor 8 is brought to close proximity to the LEDs, it is possible for it to provide its own shading to effectively reduce sunlight during the testing procedure itself.

A yet further possible embodiment is shown in FIG. 9. In this case, the display panel 2 with a plurality of forward facing LEDs 12 might be provided with a boarder region 24 that does not form part of the normal display. Instead, the boarder region 24 may comprise a panel directed back towards the display panel carrying an optical sensor 26 to view a plurality of LEDs 25 on the display panel 2. These pixels 25 are provided as additional LEDs in the same manner as those on the reverse of the PCB although located on the front face for convenience. The sunlight S can be effectively blocked from the LEDs 25 by the panel 24. Furthermore, these LEDs 25 can be met to different portions of the overall display to continue to receive an average workload indicative of the LEDs in the display itself.

A yet further possible embodiment is shown in FIG. 11. In this embodiment, the display panel 2 is again provided with forward facing LEDs 12 that are generally supported and connected to circuitry on the back of the PCB forming the display panel 2 by legs 27.

In this alternative embodiment, optical fibres 28 protrude through the display panel 2 such that they are adjacent the forward facing LEDs 12. The optical fibres 28 can carry the light from the LEDs 12 directly back to a processor for analysis. If the optical fibre 28 progresses through the display panel 2 so as to lie directly adjacent the LED 12, it may be positioned to lie underneath the shade of a louver 29. Such louvers are often provided on such display panels to limit the sunlight directly falling onto the LEDs and then prove contrast. Positioning the optical fibres 28 directly below the louver beside the LED 12 may allow the optical fibre to carry information on the light produced by the LED with minimal interference from sunlight. Again it would be anticipated that a plurality of optical fibres 28 are employed throughout the screen to carry back representative information on the performance or content of the screen itself.

In a yet further alternative or additional embodiment, it is also possible to include an extra non-perceptible display unit such as an LED working in the infrared bank 30 as shown in FIG. 9. This additional item working in the infrared bank can achieve some of the desired objectives of the invention on its own. For example, it is possible to transmit a verification code through the infrared item 30 to be received by a suitable infrared receiver. The infrared device itself can be run off a signal contained in the data stream. Furthermore, the item 30 can comprise some form of transmitter to transmit infrared signals that may be received by those required to service the unit in the area should there be any problems with the display. As a yet further possibility, an infrared transmitter included with the display can send out additional information beyond the visual picture on the display itself to be received by any infrared receiver that might be suitable. For example, it would be possible to send the information to be received by infrared receiving mobile phones.

Thus it can be seen that the invention provides a number of alternative embodiments that seek to verify the content on a display or check the performance and monitor the actions of a display.

The invention has been described with reference to a number of embodiments but should not be considered restricted to those particular embodiments. Specific integers referred to throughout the description are deemed to incorporate known equivalence where appropriate.

1. A display for displaying a time-dependent image comprising:
a display panel for displaying the image;
receiving means to receive an incoming data stream containing images and including at least an intermittent verification signal;
a processor to process the data feed and drive the display to present said images; and
a control means to check for the verification signal in either the data feed or the display image and control the display if an appropriate verification signal is not present.

2. A display for displaying a time-dependent image as claimed in claim 1 wherein the control means will control the display by removing from display any images that are not accompanied by a verification signal.

3. A display for displaying a time-dependent image as claimed in claim 1 wherein the control means will also provide a signal to a remote controller to alert as to the absence of the verification signal.

4. A display for displaying a time-dependent image as claimed in claim 1 wherein said control means is included with said processor of the data feed for the display of the image.

5. A display for displaying a time-dependent image as claimed in claim 1 wherein said control means includes checking for the presence of a verification signal provided to at least a visible or non-visible portion of the display.

6. A display for displaying a time-dependent image as claimed in claim 5 wherein said visible or non-visible portion of the display is read by at least one optical sensor to check for the verification signal.

7. A display for displaying a time-dependent image as claimed in claim 6 wherein said verification signal is provided to a visible portion of the display in a manner not perceptible to a human observer of the display.

8. A display for displaying a time-dependent image as claimed in claim 1 wherein said apparatus also transmits acknowledgement of receipt or display of correct images to said remote controller.

9. A method verifying a data feed or image on a remote display screen comprising:
combining a verification signal in a data feed containing the desired images for display;
sending said data feed and said verification signal to said display;
checking the incoming data feed or the display image for the presence of the verification signal; and
controlling the display screen in response to receipt of a data feed or display of an image not containing said verification signal.

10. A method verifying a data feed or image on a remote display screen as claimed in claim 9 wherein said step of controlling the display screen comprises failing to display images not containing said verification signal and/or transmitting a signal to a remote controller indicating the receipt or display of images without said verification signal.

11. A method verifying a data feed or image on a remote display screen as claimed in claim 9 wherein said step of checking for the verification signal is done on the incoming data feed.

12. A method verifying a data feed or image on a remote display screen as claimed in claim 9 wherein the step of checking for the verification signal is performed on the display image.

13. A method verifying a data feed or image on a remote display screen as claimed in claim 9 wherein said step of checking is performed on a non-visible display portion.

14. A method verifying a data feed or image on a remote display screen as claimed in claim 9 wherein said checking of the presence of a verification signal in a display image comprises optically checking for the omission of a verification signal by units within the display.

15. A method verifying a data feed or image on a remote display screen as claimed in claim 9 wherein said method further includes transmitting a signal to a remote confirming receipt or display of data feeds or images containing the verification signal.

16. A method of monitoring the performance of a display comprising:
optically sensing output from at least a representative portion of visible or non-visible display units;
providing a test signal to said display units;
comparing said optically sensed output with an expected output; and
controlling said display in accordance with the results of said comparison.

17. A method of monitoring the performance of a display as claimed in claim 16 wherein said method comprises a step of testing visible display units in a manner not perceptible to the human eye.

18. A method of monitoring the performance of a display as claimed in claim 16 wherein said method includes testing display units hidden from a viewer during normal display.

19. A method of monitoring the performance of a display as claimed in claim 18 wherein said display units not visible during normal use of the display also receive representative data representing the workload of visible display units.

20. A method of monitoring the performance of a display as claimed in claim 16 wherein said method includes provision of a specific test signal only to said representative portion of visible or non-visible display units.

21. A display for displaying time-dependent images comprising:
a display panel containing a plurality of display units for displaying said time-dependent images;
at least one optical sensor to sense output from at least a representative portion of visible or non-visible display units;
comparing means to compare the sensed optical output with an expected or desired output; and
control means to control the display in response to the result of said comparison.

22. A display for displaying time-dependent images as claimed in claim 21 wherein said display contains display units that are not visible to an ordinary viewer of the display images.

23. A display for displaying time-dependent images as claimed in claim 21 wherein said display tests visible display units in a manner not perceptible to the human eye.
